(19) United States
(12) Patent Application Publication
(10) Pub. No.: US 2022/0250908 A1
(43) Pub. Date: Aug. 11, 2022

(54) SULFUR DIOXIDE MIXTURE, AND METHOD OF PRODUCING THE SAME, AND FILLING CONTAINER

(71) Applicant: SHOWA DENKO K.K., Tokyo (JP)

(72) Inventors: Yosuke TANIMOTO, Tokyo (JP); Hideyuki KURIHARA, Tokyo (JP)

(73) Assignee: SHOWA DENKO K.K., Tokyo (JP)

(21) Appl. No.: 17/595,708

(22) PCT Filed: Feb. 17, 2021
(86) PCT No.: PCT/JP2021/005912

§ 371 Date: Nov. 23, 2021

(30) Foreign Application Priority Data
Mar. 9, 2020 (JP) 2020-040137

(51) Int. Cl. C01B 17/56; B65D 85/84

(52) U.S. Cl. CPC C01B 17/56; C01P 2006/80; B65D 85/84

(57) ABSTRACT

Provided is a sulfur dioxide mixture that hardly corrodes metals. A sulfur dioxide mixture contains sulfur dioxide and water. The sulfur dioxide mixture is filled in a filling container in such a manner that a gas phase and a liquid phase exist, and the moisture concentration of the gas phase is from 0.005 mole ppm to less than 5,000 mole ppm.

### TECHNICAL FIELD

The present invention relates to a sulfur dioxide mixture, a method of producing the same, and a filling container.

### BACKGROUND ART

Sulfur dioxide (SO₂) has traditionally been used in a variety of applications, such as food additives, raw materials for industrial chemicals, and raw materials for pharmaceuticals, and in recent years, sulfur dioxide has been increasingly used in semiconductor microfabrication applications. Semiconductor microfabrication applications need high-purity sulfur dioxide, and there is a growing demand to improve the quality of such products.

However, liquefied sulfur dioxide filled in a filling container had the following problems. Specifically, sulfur dioxide contains a minute amount of moisture that is difficult to remove in a producing process, and even when high-purity sulfur dioxide with a sufficiently low moisture concentration is filled in a filling container, the moisture concentrates in the container, and sulfur dioxide gas with an insufficiently low moisture concentration may be released from the filling container. This problem will be described in detail below.

When vaporized sulfur dioxide gas is released from a filling container, liquefied sulfur dioxide evaporates to maintain vapor-liquid equilibrium in the filling container. In that case, since water, which has a vapor-liquid equilibrium constant of about 0.5, evaporates less than sulfur dioxide, water tends to remain in the liquid phase, and as sulfur dioxide gas is released, water becomes concentrated in the filling container. Therefore, in an early stage of release, the amount of water accompanying the sulfur dioxide gas is minute and the water concentration of the sulfur dioxide gas is sufficiently low, and as the liquid phase decreases due to evaporation, the amount of water accompanying the sulfur dioxide gas gradually rises and the moisture concentration of the sulfur dioxide gas increases.

For example, the moisture concentration in the liquid phase of sulfur dioxide, which is generally referred to as a high-purity product, is about 500 mole ppm when filling of the filling container is completed, and when water is concentrated on the liquid phase as sulfur dioxide gas is released from the filling container, and all of the liquefied sulfur dioxide is eventually gasified, the moisture concentration in the gas phase rises to 50,000 mole ppm. Although there are products on the market with a lower moisture concentration, the moisture concentration in the liquid phase at the completion of filling the filling container is still about 60 mole ppm, and the moisture concentration in the gas phase when all of the liquefied sulfur dioxide is eventually gasified is 6,000 mole ppm.

When the moisture concentration of sulfur dioxide gas is high, moisture tends to adhere to the inner wall of piping where sulfur dioxide gas flows. Sulfur dioxide is absorbed by this moisture and becomes sulfurous acid, or is further oxidized to sulfuric acid, which may cause corrosion and deterioration of the piping, increasing repair costs. Leakage of sulfur dioxide gas, which is harmful to a human body, due to progressive deterioration of piping may lead to a disaster accident. Furthermore, when heavy metals such as nickel, chromium, and iron leached from piping in many cases made or stainless steel due to corrosion accompany sulfur dioxide gas, the heavy metals may adhere to the wafer surface and contaminate the wafer when sulfur dioxide gas is used as an etching gas for semiconductor wafers, for example.

To solve this problem, Patent Document 1, for example, discloses a method of removing moisture in sulfur dioxide gas by contacting sulfur dioxide gas containing impurities with a sulfuric acid solution having a temperature difference. In Examples in Patent Document 1, sulfur dioxide gas with a moisture concentration of 1 mg/kg (3.6 volume ppm) is produced.

However, since Patent Document 1 does not disclose the moisture concentration of sulfur dioxide gas needed to inhibit metal corrosion, the technology disclosed in Patent Document 1 had difficulty in providing sulfur dioxide capable of inhibiting metal corrosion filled in a filling container in such a manner that the gas phase and the liquid phase were present.

### CITATION LIST

### Patent Literature

PTL 1: JP 2012-66962 A

### SUMMARY OF INVENTION

### Technical Problem

Accordingly, an object of the present invention is to provide a sulfur dioxide mixture that does not corrode metals easily and a method of producing the same, by solving problems of conventional technologies as described above. Another object of the present invention is to provide a filling container filled with a sulfur dioxide mixture that hardly corrodes metal.

### Solution to Problem

To solve the above-described problems, one aspect of the present invention is as described in [1] to [11] below.

[1] A sulfur dioxide mixture containing sulfur dioxide and water, the mixture being filled in a filling container in such a manner that a gas phase and a liquid phase exist, and the moisture concentration of the gas phase being from 0.005 mole ppm to less than 5,000 mole ppm.
[2] A sulfur dioxide mixture containing sulfur dioxide and water, the mixture being filled in a filling container in such a manner that a gas phase and a liquid phase exist, and the moisture concentration of the liquid phase being from 0.01 mole ppm to less than 50 mole ppm.
[3] The sulfur dioxide mixture according to [1] or [2], the ratio V/G₀ of the internal volume V (unit: L) of the filling container to the initial filling amount G₀ (unit: kg) of the sulfur dioxide mixture into the filling container is from 0.80 to 2.00.
[4] A method of producing a sulfur dioxide mixture containing sulfur dioxide and water, the method including: a dehydration step in which a sulfur dioxide mixture having a moisture concentration of 500 mole ppm or more is brought into contact with a moisture adsorbent to make the moisture concentration less than 50 mole ppm; and, a filling step in which a sulfur dioxide mixture obtained in the dehydration step is filled in a filling container to have a gas phase and a liquid phase, and to have a moisture concentration of the liquid phase of from 0.01 mole ppm to less than 50 mole ppm at a time of completion of filling.
[5] The method of producing a sulfur dioxide mixture according to [4], at least a portion of the filling container is made of stainless steel.
[6] The method of producing a sulfur dioxide mixture according to [4] or [5], in which the ratio V/G1 of the internal volume V (unit: L) of the filling container to the filling amount G1 (unit: kg) of the sulfur dioxide mixture into the filling container in the filling step is from 0.30 to 115.
[7] A filling container filled with a sulfur dioxide mixture containing sulfur dioxide and water, the sulfur dioxide mixture being filled to form a gas phase and a liquid phase, and the moisture concentration of the gas phase being from 0.005 mole ppm to 5,000 mole ppm.
[8] A filling container filled with a sulfur dioxide mixture containing sulfur dioxide and water, the sulfur dioxide mixture being filled to form a gas phase and a liquid phase, and the moisture concentration of the liquid phase being from 0.01 mole ppm to less than 50 mole ppm.
[9] The filling container according to [7] or [8], in which the ratio V/G₀ of the internal volume V (unit: L) to the initial filling amount G₀ (unit: kg) of the sulfur dioxide mixture is from 0.80 to 2.00.
[10] The filling container according to any one of [7] to [9], in which the volume of the filling container is from 1 L to 2,000 L.
[11] The filling container according to anyone of [7] to [10], in which at least a portion of the filling container is made of stainless steel.

### Advantageous Effects of Invention

According to the present invention, a sulfur dioxide mixture that hardly corrodes metals can be provided.

### DESCRIPTION OF EMBODIMENTS

The present invention specifies the moisture concentration in a sulfur dioxide mixture for inhibiting corrosion of metals by sulfur dioxide. It is generally known that metal corrosion by sulfur dioxide is strongly affected by moisture concentration, but how moisture concentration at a ppm level affects the corrosion has not been found.

Accordingly, the present inventors intensively studied metal corrosion caused by trace amounts of moisture in sulfur dioxide, and surprisingly found that metal corrosion is considerably suppressed when the moisture concentration is sufficiently low at a ppm level, thereby completing the present invention. One embodiment of the present invention is described in detail below.

The sulfur dioxide mixture of the present embodiment contains sulfur dioxide and water. The filling container of the present embodiment is a filling container filled with the sulfur dioxide mixture. The sulfur dioxide mixture is filled into the filling container to form a gas phase and a liquid phase, and the moisture concentration of the gas phase is from 0.005 mole ppm to less than 5,000 mole ppm.

By setting the moisture concentration of the gas phase in the above-described range, corrosion of metals used for piping or the like can-, be suppressed. By setting the moisture concentration of the liquid phase when filling of the sulfur dioxide mixture into the filling container is completed at from 0.01 mole ppm to less than 50 mole ppm, the moisture concentration of the gas phase can be maintained in the above-described range. When the moisture concentration of the liquid phase of the sulfur dioxide mixture at the time of completion of filling the filling container is in the above-described range, it is easy to maintain the moisture concentration of the gas phase in the above-described range even when the moisture concentration of the liquid phase increases as the sulfur dioxide mixture gas in the filling container is released, thereby inhibiting corrosion of the above-described metal.

In other words, a product is composed of a filling container and a sulfur dioxide mixture, and the sulfur dioxide mixture contains sulfur dioxide and water. The sulfur dioxide mixture is filled into the filling container to form a gas phase and a liquid phase, and the water concentration of the gas phase is from 0.005 mole ppm to less than 5,000 mole ppm, and the moisture concentration of the liquid phase at the completion of filling to achieve this is from 0.01 mole ppm to less than 50 mole ppm. The filling container may be at least partly composed of stainless steel.

The moisture concentration of the gas phase described above is the moisture concentration between the time when the filling of the sulfur dioxide mixture into the filling container is completed and the time when almost all of the sulfur dioxide mixture in the filling container released.

During that time, the moisture concentration of the gas phase of the sulfur dioxide mixture in the filling container gradually increases in the above-described range due to release of the sulfur dioxide mixture gas.

When the moisture concentration in the gas phase of a sulfur dioxide mixture in which a gas phase rid a liquid phase coexist is less than 0.01 mole ppm, it is difficult to measure the moisture concentration directly, and therefore, ½ of the moisture concentration in the liquid phase is regarded as the moisture concentration in the gas phase. This is based on the fact that the present inventors have experimentally confirmed that the moisture concentration in a sulfur dioxide mixture in which a gas phase and a liquid phase coexist is: moisture concentration in gas phase:moisture concentration in liquid phase=1:2.

Since the moisture concentration in the liquid phase of such a sulfur dioxide mixture is extremely low when filling of a filling container is completed, the moisture concentration in the liquid phase is maintained at a sufficiently low level until the entire amount of the liquefied sulfur dioxide mixture in the filling container is vaporized, even when the moisture is concentrated in the liquid phase as the vaporized sulfur dioxide mixture gas is released from the filling container. Therefore, the moisture concentration of the sulfur dioxide mixture gas released from the filling container is sufficiently low from the beginning of the release to the end of the release (when all of the liquefied sulfur dioxide mixture in the filling container is vaporized). Therefore, metal corrosion caused by the sulfur dioxide mixture gas released from the filling container can be considerably suppressed until the end of the release.

The moisture concentration in the liquid phase at the time of completion of filling into the filling container is from 0.01 mole ppm to 50 mole ppm, and preferably from 0.01 mole ppm to 10 mole ppm, more preferably from 0.01 mole ppm to 3.5 mole ppm, and still more preferably from 0.01 mole ppm to 1.0 mole ppm.

Based on the fact that the moisture concentration in the sulfur dioxide mixture in which the gas phase and the liquid phase coexist is: moisture concentration in gas phase:moisture concentration in liquid phase=1:2, the moisture concentration in the gas phase at the time of completion of filling the filling container is preferably less than 25 mole ppm, more preferably less than 5 mole ppm, still more preferably less than 1.7 mole ppm, and most preferably less than 0.5 mole ppm.

When the moisture concentration of the liquid phase is less than 50 male ppm, the moisture concentration of the sulfur dioxide mixture gas released from the filling container is maintained at a level that inhibits metal corrosion (for example, less than 5,000 male ppm) until the end of the release, even when the moisture is concentrated on the liquid phase as the sulfur dioxide mixture gas is released from the filling container. Moisture concentrations lower than 0.01 mole ppm are hard to be confirmed.

As described above, the sulfur dioxide mixture in the filling container and the sulfur dioxide mixture gas released from the filling container have a low moisture concentration, and hardly corrode metals. Therefore, there is no need to use expensive corrosion-resistant alloys such as Hastelloy (registered trademark) for portions in contact with a sulfur dioxide mixture in the filling container and sulfur dioxide mixture gas released from the filling container, and metals such as stainless steel can be used. For example, portions of a filling container, a piping, a production apparatus, a feeding apparatus, a transfer apparatus, a reaction apparatus, and the like that come into contact with a sulfur dioxide mixture can be composed of metals such as stainless steel.

The types of stainless steel that can be used are not particularly limited, and examples of stainless steel include SUS316, SUS316L, SUS304, and SUS304L.

The initial filling amount G₀ (unit: kg) of sulfur dioxide mixture into a filling container is the filling amount at the completion of the filling step, which is not particularly limited, and may be from 40% to 100% of the upper limit of mass calculated according to the internal volume V of a filling container, as specified in Article 48, Paragraph 4 of the High Pressure Gas Safety Act and Article 22 of the Container Safety Regulations. In other words, the ratio V of the internal volume V (unit: L) of the filling container to the initial filling amount G₀ (unit: kg) of the sulfur dioxide mixture into the filling container is not particularly limited, and may ne from 0.80 to 2.00.

When the ratio V/G₀ is 0.80 or more (or when the initial filling amount G₀ of the sulfur dioxide mixture into the filling container is 100% or less of the upper limit of mass calculated according to the internal, volume V of the filling container), the filling of the sulfur dioxide mixture into the filling container is safe because the container is not overfilled. On the other hand, when the ratio V/G₀ is 2.00 or less (or when the initial filling amount G₀ of the sulfur dioxide mixture into the filling container is 40% or more of the upper limit of the mass calculated according to the internal volume V of the filling container), the initial filling amount G₀ of the sulfur dioxide mixture is sufficient for the internal volume V of the filling container, and therefore the transportation of efficiency of the sulfur dioxide mixture by the filling container is high.

The ratio V/G₀ of the internal volume V (unit: L) of the filling container to the initial filling amount G₀ (unit: kg) of the sulfur dioxide mixture into the filling container is more preferably from 1.00 to 1.90, and still more preferably from 1.10 to 1.80.

Next, one embodiment of a method of producing a sulfur dioxide mixture as described above will be described. First, moisture is removed from the sulfur dioxide mixture gas with a moisture concentration of 500 mole ppm or more in a dehydration step to contain a sulfur dioxide mixture gas with a moisture concentration of less than 50 mole ppm. In the dehydration step, the sulfur dioxide mixture gas with a moisture concentration of 500 mole ppm or more is dehydrated by contacting a moisture adsorbent to reduce the moisture concentration to less than 50 mole ppm.

The type of moisture adsorbent is not particularly limited as long as the moisture concentration of the sulfur dioxide mixture gas can be reduced to less than 50 mole ppm, and examples thereof include zeolite, activated carbon, silica gel, and diphosphorus pentoxide. The type of zeolite is not particularly limited, and the ratio of silica to alumina contained in the zeolite and the pore size of the pores are not particularly limited, but preferably those with resistance to sulfur dioxide, and examples thereof include molecular sieve 3A and high-silica zeolite.

The sulfur dioxide mixture gas, whose moisture concentration has been reduced to less than 50 mole ppm by the dehydration step, is compressed and partially liquefied in a filling step, and then filled into a filling container with a capacity of from 1 L to 2,000 L, for example. In the filling step, the sulfur dioxide mixture gas is compressed and filled in such a manner that a part of the gas becomes liquid and the moisture concentration in the liquid phase at the completion of filling is from 0.01 mole ppm to less than 50 mole ppm.

Although the method of compressing the sulfur dioxide mixture gas and filling the filling container is not limited, for example, the sulfur dioxide mixture gas is liquefied by boosting the pressure with a compressor, the low and high boiling point components are removed using a distillation column, and then the gas is stored in a product tank and transferred from the product tank to the filing container for filling.

The capacity of the filling container can be from 1 L to 2,000 L, and is preferably from 2 L to 1,800 L, and more preferably is from 3 L to 1,500 L. When the capacity of the filling container is 1 L or more, the efficiency is excellent because the amount of usable sulfur dioxide mixture is large. On the other hand, when the capacity of the filling container is 2,000 L or less, the filling container is easy to fabricate and transport.

When filling the filling container with the sulfur dioxide mixture, the temperature of the filling container is not limited, and the container may be pre-cooled to a temperature of from −90° C. to 0° C. Furthermore, since residual moisture in the filling container will increase the amount or water of the filled sulfur dioxide mixture, the container may be pre-heated and decompressed in advance in such a manner that the amount of residual moisture in the filling container is 0.1 mole ppm or less.

Furthermore, the ratio V/G₁ of the internal volume V (unit: L) of the filling container to the filling amount S₁ (unit: kg) of the sulfur dioxide mixture in the filling step is not particularly limited, and may be from 80 to 115. When the ratio V/G₁ is 0.80 or more, the filling of sulfur dioxide mixture into the filling container is not over filling, which is safe. On the other hand, when the ratio v/G₁ is 115 or less, the sulfur dioxide mixture is easily liquefied.

The ratio V/G₁ of the internal volume V (unit: L) of the filling container to the filling amount G: (unit: kg) of the sulfur dioxide mixture into the filling container in the filling step is preferably from 1.00 to 1.90, and further preferably from 1.10 to 1.80.

The method of measuring the moisture concentration of the sulfur dioxide mixture in each step of the method of producing a sulfur dioxide mixture (dehydration step and filling step) is not particularly limited, as long as the method is capable of accurately measuring the moisture concentration down to about 0.01 mole ppm. Examples thereof include a method of using a mirror-cooled dew point meter, a Fourier transform infrared spectrometer (FT-IR), a phosphorus pentoxide moisture meter, or the like, and a cavity ring-down spectroscopy (CPDS) method.

In the case of the gas phase, the moisture concentration is measured by cavity ring down spectroscopy method after removing a sample from the gas phase of the filling container. On the other hand, in the case of the liquid phase, the sample is gasified after being removed from the liquid phase portion of the filling container, and measured by cavity ring down spectroscopy as in the case of the gas phase.

According to such a method of producing a sulfur dioxide mixture in the present embodiment, a sulfur dioxide mixture with an extremely low moisture concentration, which hardly corrodes metals such as stainless steel, can be produced with simple equipment. A sulfur dioxide mixture produced by the method of producing a sulfur dioxide mixture of the present embodiment can be used as an additive gas to etching gas used for etching in a manufacturing process of semiconductors and thin-film transistors or as a gas for interface treatment.

Furthermore, a sulfur dioxide mixture obtained by the method of producing a sulfur dioxide mixture of the present embodiment can also be used for the production of various chemicals, such as pharmaceuticals and dye intermediates.

The present embodiment is one example of the present invention, and the present invention is not limited to the present embodiment. Various changes or improvements can be made to the present embodiment, and such changes or improvements can also be included in the present invention.

### EXAMPLES

The present invention will be described in more detail by way of Examples and Comparative Examples below.

### Example 1

Thirty kilograms of sulfur dioxide mixture containing sulfur dioxide and water was filled into a filling container with a capacity of 47 L at a pressure of 0.23 MPaG (gauge pressure) in such a manner that the mixture was partially liquid. The ratio V/G₀ of the internal volume V of the filling container to the initial filling amount G₀ of the container is 1.57. The sulfur dioxide mixture in the filling container was divided into a gas phase and a liquid phase, and the moisture concentration in the liquid phase at the completion of filling was 40 mole ppm.

The gas phase was removed from the filling container at a release rate of 2 L/min until the remaining amount of the sulfur dioxide mixture in the filling container was 0.4 kg. In this state, the liquid phase in the filling container disappeared and the entire amount of the sulfur dioxide mixture was gasified, and the moisture concentration of the sulfur dioxide mixture gas in the filling container was 4,000 mole ppm. In other words, it can be regarded that the moisture concentration of the gas phase of the sulfur dioxide mixture was 4,000 mole ppm or less while part of the above-described sulfur dioxide mixture was in the liquid phase.

A rectangular-shaped (10 mm wide, 50 mm, long, and 1 mm thick) test piece made of SUS316L was prepared, and after measuring the mass, the piece was suspended in a pressure-resistant container using a Teflon (registered trademarking) string. Sulfur dioxide mixture gas with the above-described moisture concentration of 4,000 mole ppm was introduced into this pressure-resistant container, and the internal pressure was set to 0.15 MPaG (gauge pressure).

This pressure-resistant container was heated to 100° C. for five days, and then purged with N₂ gas sufficiently to confirm that the sulfur dioxide concentration was less than 0.1 mole ppm, the pressure-resistant container was opened, and the test piece was taken out. The taken out test piece was ultrasonically cleaned with ultrapure water and 10% by mass aqueous nitric acid solution for 10 minutes each, dried, and then the mass was measured, and the corrosion rate was calculated from the mass change. As a result, the corrosion rate was 0.93 μm/y. As can be seen, the progress of corrosion due to the residual sulfur dioxide mixture gas was considerably slow even when 98% of the initial filling amount G₀ was released.

### Example 2

The same operation as in Example 1 was carried out except that the moisture concentration of the liquid phase at the time of completion of filling the filling container was 9.5 mole ppm, and a sulfur dioxide mixture gas with a moisture concentration of 950 mole ppm in the gas phase after removing the gas phase until the liquid phase of the sulfur dioxide mixture in the filling container disappeared, or until the remaining volume was 0.4 kg was obtained. The same operation as in Example 1 was performed except that this sulfur dioxide mixture gas was used, and the corrosion rate of the test piece was measured to be 0.72 μm/y.

### Examples 3 to 4, Comparative Examples 1 to 2

In Examples 3 to 4 and Comparative Examples 1 to 2, the corrosion rate of the test piece was measured by performing the same operation as in Example 2, except that the “moisture concentration of the liquid phase at the time of completion of filling” and the “moisture concentration of the gas phase after removing the gas phase until the remaining volume was 0.4 kg” were set to the values illustrated in Table 1. The results are illustrated in Table 1.

From these results (see Table 1), it can be seen that when the moisture concentration of the liquid phase at the completion of filling the filling container is less than 50 mole ppm, the moisture concentration of the sulfur dioxide mixture gas released from the filling container is sufficiently low until the end of the release (when the entire amount of the liquefied sulfur dioxide mixture in the filling container is gasified), thereby considerably inhibiting metal corrosion.

TABLE 1

| | | | | | Comparative | Comparative |
|---|---|---|---|---|---|---|
| | Example 1 | Example 2 | Example 3 | Example 4 | Example 1 | Example 2 |
| Moisture concentration | 40 | 9.5 | 2.5 | 0.15 | 50 | 90 |
| in liquid phase at | | | | | | |
| completion of filling | | | | | | |
| (mole ppm) | | | | | | |
| Moisture concentration | 4000 | 950 | 250 | 15 | 5000 | 9000 |
| (mole ppm) in gas phase | | | | | | |
| after gas phase was | | | | | | |
| removed until the | | | | | | |
| residual amount was 0.4 | | | | | | |
| kg. | | | | | | |
| Corrosion rate (μm/y) | 0.93 | 0.72 | 0.54 | 0.44 | 8.6 | 51 |

### Example 5

Next, an Example of a method of producing a sulfur dioxide mixture with a moisture concentration of less than 50 mole ppm in the liquid phase is described. Thirty kilograms of crude sulfur dioxide mixture gas with a moisture concentration of 500 mole ppm was fed to a moisture adsorption tower (320 L capacity) at a flow rate of 320 m³/h, and dehydrated by contacting 260 kg of moisture adsorbent (Molecular Sieve 3A manufactured by Union Showa Corporation) filled in the moisture adsorption tower.

The distribution velocity of the crude sulfur dioxide mixture gas has a linear velocity (LV) of 10 m/min and a space velocity (SV) of 1,000/h. The moisture concentration of the sulfur dioxide mixture gas at the outlet of the moisture adsorption tower was 4.2 mole ppm.

Thirty kilograms of this sulfur dioxide mixture gas with a moisture concentration of 4.2 mole ppm was filled into a filling container with a capacity of 47 L while the pressure was increased to about 0.23 MPaG (gauge pressure) by a pump.

The moisture concentration of the liquefied sulfur dioxide mixture (liquid phase) in the filling container was 5.8 mole ppm.

1. A sulfur dioxide mixture containing sulfur dioxide and water, the mixture being filled in a filling container in such a manner that a gas phase and a liquid phase exist, and the moisture concentration of the gas phase being from 0.005 mole ppm to less than 5,000 mole ppm.

2. A sulfur dioxide mixture containing sulfur dioxide and water, the mixture being filled in a filling container in such a manner that a gas phase and a liquid phase exist, and the moisture concentration of the liquid phase being from 0.01 mole ppm to less than 50 mole ppm.

3. The sulfur dioxide mixture according to claim 1, the ratio V/G₀ of the internal volume V (unit: L) of the filling container to the initial filling amount G₀ (unit: kg) of the sulfur dioxide mixture into the filling container is from 0.80 to 2.00.

4. A method of producing a sulfur dioxide mixture containing sulfur dioxide and water, the method including:
a dehydration step in which a sulfur dioxide mixture having a moisture concentration of 500 mole ppm or more is brought into contact with a moisture adsorbent to make the moisture concentration less than 50 mole ppm; and
a filling step in which a sulfur dioxide mixture obtained in the dehydration step is filled in a filling container to have a gas phase and a liquid phase, and to have a moisture concentration of the liquid phase of from 0.01 mole ppm to less than 50 mole ppm at a time of completion of filling.

5. The method of producing a sulfur dioxide mixture according to claim 4, at least a portion of the filling container is made of stainless steel.

6. The method of producing a sulfur dioxide mixture according to claim 4, wherein the ratio V/G₁ of the internal volume V (unit: L) of the filling container to the filling amount G₁ (unit: kg) of the sulfur dioxide mixture into the filling container in the filling step is from 0.80 to 115.

7. A filling container filled with a sulfur dioxide mixture containing sulfur dioxide and water, the sulfur dioxide mixture being filled to form a gas phase and a liquid phase, and the moisture concentration of the gas phase being from 0.005 mole ppm to 5,000 mole ppm.

8. A filling container filled with a sulfur dioxide mixture containing sulfur dioxide and water, the sulfur dioxide mixture being filled to form a gas phase and a liquid phase, and the moisture concentration of the liquid phase being from 0.01 mole ppm to less than 50 mole ppm.

9. The filling container according to claim 7, wherein the ratio V/G₀ of the internal volume V (unit: L) to the initial filling amount G₀ (unit: kg) of the sulfur dioxide mixture is from 0.80 to 2.00.

10. The filling container according to claim 7, wherein the volume of the filling container is from 1 L to 2,000 L.

11. The filling container according to claim 7, wherein at least a portion of the filling container is made of stainless steel.

12. The sulfur dioxide mixture according to claim 2, the ratio V/G₀ of the internal volume V (unit: L) of the filling container to the initial filling amount G₀ (unit: kg) of the sulfur dioxide mixture into the filling container is from 0.80 to 2.00.

13. The method of producing a sulfur dioxide mixture according to claim 5, wherein the ratio V/G₁ of the internal volume V (unit: L) of the filling container to the filling amount G₁ (unit: kg) of the sulfur dioxide mixture into the filling container in the filling step is from 0.80 to 115.

14. The filling container according to claim 8, wherein the ratio V/G₀ of the internal volume V (unit: L) to the initial filling amount G₀ (unit: kg) of the sulfur dioxide mixture is from 0.80 to 2.00.

15. The filling container according to claim 8, wherein the volume of the filling container is from 1 L to 2,000 L.

16. The filling container according to claim 9, wherein the volume of the filling container is from 1 L to 2,000 L.

17. The filling container according to claim 8, wherein at least a portion of the filling container is made of stainless steel.

18. The filling container according to claim 9, wherein at least a portion of the filling container is made of stainless steel.

19. The filling container according to claim 10, wherein at least a portion of the filling container is made of stainless steel.
